(19) United States
(12) Patent Application Publication
(10) Pub. No.: US 2018/0112681 A1
(43) Pub. Date: Apr. 26, 2018

(54) HYDRAULIC ACCUMULATOR

(71) Applicant: HYDAC TECHNOLOGY GMBH, Sulzbach/Saar (DE)

(72) Inventors: Peter KLOFT, Ransbach-Baumbach (DE); Herbert BALTES, Losheim (DE); Michael WEIS, Olsbruecken (DE)

(73) Assignee: HYDAC TECHNOLOGY GMBH, Sulzbach/Saar (DE)

(21) Appl. No.: 15/569,849

(22) PCT Filed: Apr. 13, 2016
(86) PCT No.: PCT/EP2016/000603

§ 371 Date: Oct. 27, 2017

(30) Foreign Application Priority Data
Apr. 28, 2015 (DE) 10 2015 005 395.7

(51) Int. Cl. F15B 1/24

(52) U.S. Cl. CPC F15B 1/24; F15B 2201/40; F15B 2201/31

(57) ABSTRACT

The invention relates to a hydraulic accumulator, especially a piston accumulator, in which a piston part (27) separates from each other two media spaces (23, 25) inside a storage housing (1), characterized in that the piston part (27) is designed as a deep-drawn part.

The invention relates to a hydraulic accumulator, in particular a piston accumulator, in which a piston part separates two media chambers from one another inside an accumulator housing.

Hydraulic accumulators of this kind (DE 103 10 427 A1), in which the piston part in particular separates a chamber with a working gas, such as nitrogen, from a chamber with a working fluid, such as hydraulic oil, are known and commercially available in a variety of sizes and embodiments. They are widely used in hydraulic systems of various kinds, for example for the storage of hydraulic energy or for damping or smoothing out pressure fluctuations or the like.

Accumulator devices in the form of piston accumulators are frequently also used in hydraulic systems in work tools, which have hydraulic drive units, for example in mobile work machines, such as diggers, stackers, loaders or mobile cranes.

Since hydraulic accumulators are produced in large volumes because of their multiple applications, the production costs incurred represent a very significant economic factor.

Accordingly, the problem addressed by the invention is to provide a hydraulic accumulator of the type described above which can be produced in a particularly economical and cost-effective manner and which is additionally distinguished by a particularly advantageous operating performance.

According to the invention, this problem is solved by a hydraulic accumulator having the features of Claim 1 in its entirety.

According to the characterizing part of Claim 1, a significant differentiating feature of the invention is that the piston part is formed as a deep-drawn part. In a manner involving minimal material costs, it is thus possible to produce the piston part in an economical manner and with little expenditure. The design as a deep-drawn part also results in a comparatively low piston weight and thus, due to the low mass inertia, an advantageous operating performance.

In a particularly advantageous manner, the piston part can be divided into a guide part and a dome-like trough part, which serves to increase the gas working chamber on the gas side of the accumulator, with the trough part forming a pressure-balanced separation surface between the two media chambers during operation of the accumulator. This design advantageously makes a particularly large proportion of the total volume of the accumulator housing available as a gas volume.

The piston part can be provided at the external circumference with continuous circumferential groove-like recesses for receiving sealing tape and guide tape. In the case of a piston part produced as a deep-drawn part, the respective groove-like recesses can be obtained in a particularly advantageous and economical manner by means of a rolling process, which can be realized in a particularly economical manner as an additional forming step in conjunction with the deep-drawing.

The arrangement can particularly advantageously be such that one of the groove-like recesses for receiving the guide tape is arranged on one free end region of the piston part inside the guide part, with an additional second groove-like recess serving to receive the sealing tape and being arranged in the region of the transition between the guide part and the trough part either on the guide part or on the trough part. The axial spacing between the guide tape and the sealing tape thus ensures a particularly advantageous, tilt-resistant guiding of the piston part.

In the case of production as a deep-drawn part, the wall thickness of the piston part designed as a hollow piston is advantageously essentially the same over its axial extension.

For a particularly reliable guidance of the piston part, the length of the cylindrical guide part is preferably the same as or greater than half of the diameter of said guide part.

As a deep-drawn part, the piston part can be formed from a fine grain sheet, in particular from a stainless steel material or an AlMg alloy or from another metallic material suitable for a deep-drawing process.

The piston part can particularly advantageously be guided in each of its displacement positions in a hollow tube inside the accumulator housing. In such a design, as is known per se in the case of a hydraulic accumulator disclosed as subsequently published prior art in the patent application DE 10 2014 000 380.9, the accumulator housing can be produced in an economic manner and with minimal expenditure because no costly internal processing is required for a direct guidance of the piston part on the inner wall of the housing. An additional advantage is that an identically constructed unit, consisting of a hollow tube and an associated piston part, can be used for different accumulator housing sizes, so that a modular design can be realized for the production of differently dimensioned hydraulic accumulators, which permits a particularly economical production with minimal cost outlay. Another advantage is that the accumulator housing does not have to be produced from a metallic material which provides good sliding characteristics for the piston part, composite materials can also be considered, for example in the form of carbon fiber-reinforced plastic materials, which makes it possible to produce particularly light-weight hydraulic accumulators in a cost-effective manner.

The invention is explained in detail below with reference to exemplary embodiments depicted in the drawings, in which:

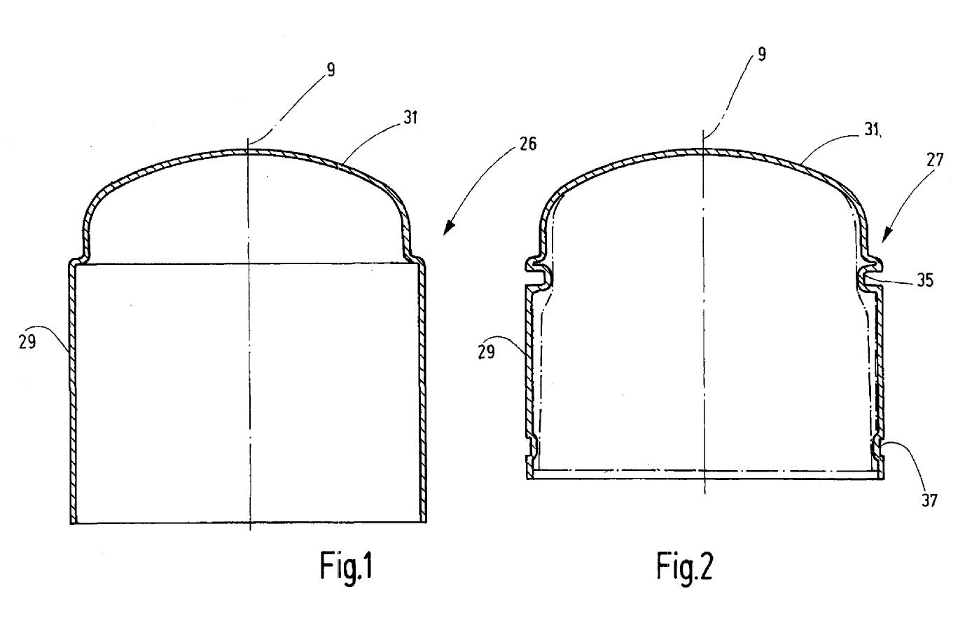

FIGS. 1 and 2 show longitudinal sections of a sheet deep-drawn part, with FIG. 1 showing the preliminary mold, which is formed by means of drawing, and FIG. 2 showing the finished mold, which is formed once the rolling has been realized, of the piston part of the hydraulic accumulator according to the invention;

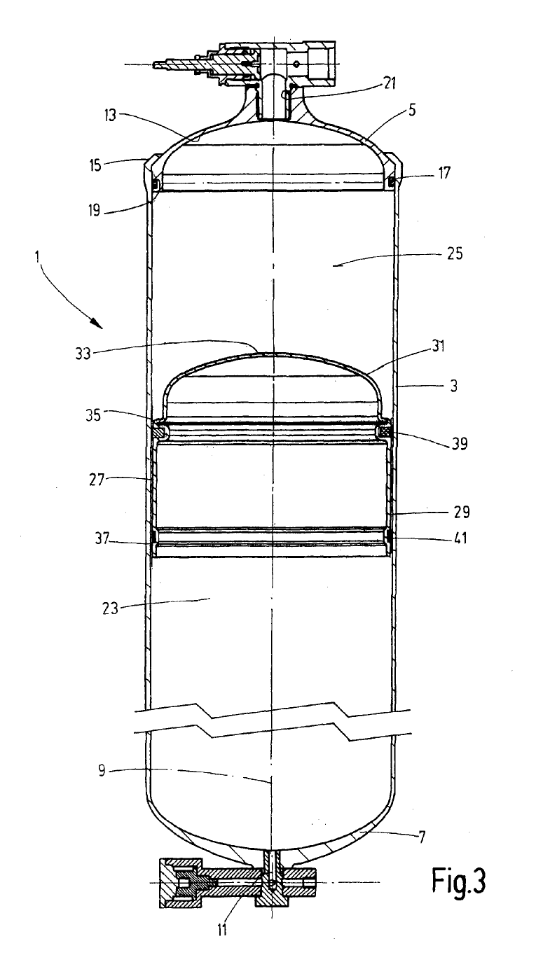

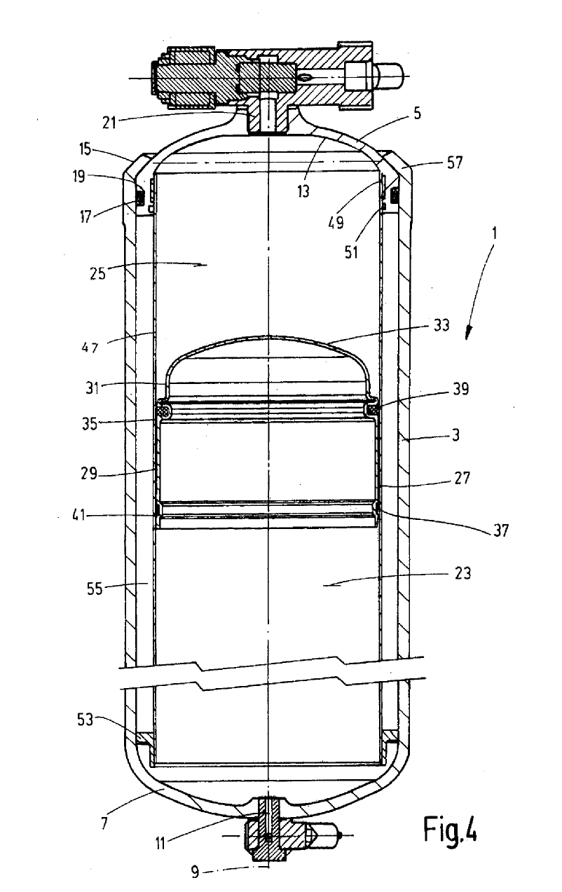

FIG. 3 shows a longitudinal section, which is depicted downscaled by a factor of 3 and shortened relative to a practical embodiment, of an exemplary embodiment of the hydraulic accumulator according to the invention and

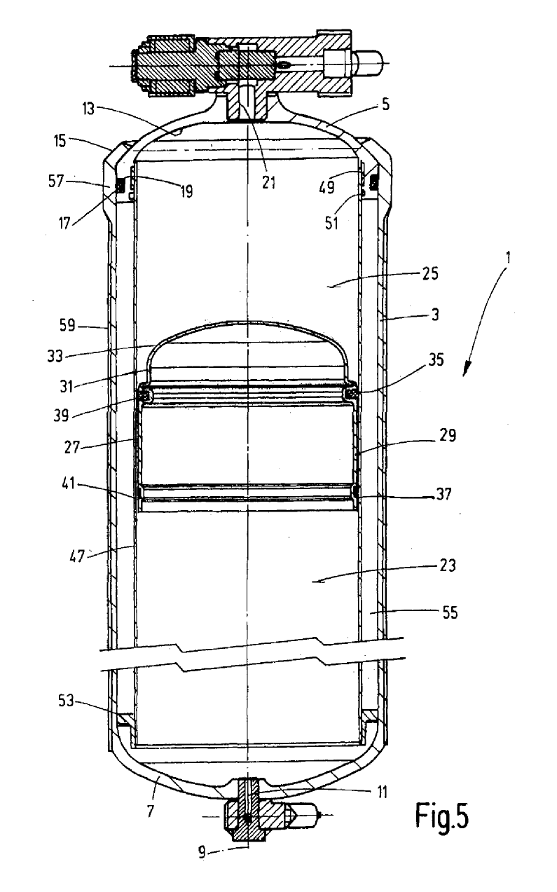

FIGS. 4 and 5 show longitudinal sections, which correspond to FIG. 3, of a second or of a third exemplary embodiment of the invention.

The exemplary embodiment in the form of a piston accumulator depicted in FIG. 3 has an accumulator housing 1 with a circular cylindrical housing main part 3, a housing cover part 5 and a base part 7. The housing main part 3 and the base part 7 form a pot, which is closed but for a gas filling connection 11 lying coaxial to the accumulator's longitudinal axis 9. The housing main part 3 and the base part 7 are formed integral, for example in the form of a deep-drawn part made from metallic material, with the base part 7 having an outwardly convex curve. In the case of the exemplary embodiment of FIG. 1 designed for a design pressure of 15 bar and a gas volume of 20 liters, an AlMg alloy is provided as a material suitable for a deep-drawing for the housing main part 3 and the base part 7, with a wall thickness of the main part 3 of 3.3 mm.

The accumulator housing can however also be differently constructed, for example in the form of a so-called liner, which is at least partially wound using plastic laminate materials.

The housing cover part 5 has a shell shape with a concave shaped inner side 13 and, as a closure part of the housing 1, it is connected by means of a flange 15 to the opening edge thereof, with an O-ring 17 in an annular groove 19 formed at the edge of the cover part 5 forming the seal. A fluid connection 21 for a corresponding working fluid, such as hydraulic oil, is provided concentric to the longitudinal axis 9 on the cover part 5. Connectors at the fluid connection 21 and also at the filling connection 11 are formed in accordance with the prior art.

As a separating element for the separation of the media chambers, namely, of the gas working chamber 23 from the fluid working chamber 25, a piston part 27 is guided in an axially freely mobile manner in the housing main part 3. This piston part 27 is formed by an integral deep-drawn part, with a fine grain sheet suitable for the deep-drawing process being provided, for example an AlMg alloy or a stainless steel material. FIG. 1 shows the preliminary mold 26 formed after the deep-drawing, from which the finished piston part 27 depicted in FIG. 2 is formed by means of rolling. As FIGS. 2 and 3 show, the piston part 27 has a shell-like or pot-like design with a guide part 29 extending axially along the inner side of the housing main part 3, to the end of which facing the cover part 5 a trough part 31 is connected, which is curved in the manner of a dome. The curvature of the trough part 31 is adapted to the concave curvature of the inner side 13 of the cover part 5, so that the piston part 27 in its top end position, i.e., in the case of an absence of fluid pressure in the fluid working chamber 25, lies with its full face against the inner side 13. The accumulator housing 1 is thus free of a residual volume of remaining fluid in this end position.

With the free mobility of the piston part 27 in the accumulator housing 1, the separation surface 33 formed by the trough part 31 between the gas working chamber 23 and the fluid working chamber 25 is pressure-balanced. The trough part 31, in a similar manner to the guide part 29, can thus be formed with lesser thickness, so that the piston part 27 constitutes a deep-drawn part with a low construction weight and the correspondingly low mass inertia results in an advantageous operating performance, for example in an application as a pulsation damper.

In order to form a piston guide and a piston seal, the piston part 27 is provided with continuous circumferential sunk grooves 35 and 37 at the external circumference. These grooves 35, 37 are each formed by means of rolling of the preliminary mold. The groove 35 lying at the top in the figure is located at the transition between the guide part 29 and the trough part 31 and forms the seat for a sealing ring 39. The other groove 37 provided at the bottom end of the guide part 29 receives another sealing element in the form of a guide tape 41.

In the exemplary embodiment of FIG. 3, the axial length of the cylindrical guide part 29 is at least half of the diameter of the guide part 29. The thus-formed axial spacing between the guide tape 41 and the sealing ring 39 allows optimal guiding of the piston part 27 in a tilt-resistant manner. The wall thickness of the piston part 27 is essentially constant throughout.

The hydraulic accumulator of the second exemplary embodiment of FIG. 4 is intended for a higher pressure level, for example for a design pressure of 350 bar. Accordingly, the accumulator housing 1 with the main part 3 and the cover part 5 is formed from a suitable stainless steel. Another difference compared with the exemplary embodiment of FIG. 3 is that the piston part 27 which, as in FIG. 3, is formed from an integral deep-drawn part, is not guided directly on the housing inner side. A running tube 47 is provided as a guide device, which extends in the housing main part 3 concentric to the axis 9. The running tube 47 is formed with little wall thickness, of 2 mm for example, from a metallic material, such as an AlMg alloy, and is fixed by means of the end lying at the top in the figure to the cover part 5. For this purpose, the end edge of the cover part 5 forms on the inner side a seat for the running tube 47 with a tolerance sleeve 49 and an O-ring seal 51. The running tube 47 thus maintained at a spacing from the inner side of the main part 3 is supported at its bottom end by means of a retaining ring 53, which is preferably formed from plastic and which has apertures (not depicted), against the housing main part 3, without a seal being formed. The gap 55 between the running tube 47 and the housing main part 3 is therefore part of the gas working chamber 23.

Because the function of guiding of the piston part 27 is realized by the running tube 47, no surface processing of the inner side of the housing main part 3 is required to form a sliding surface, so that the accumulator housing 1 can be produced in a particularly cost-effective manner. Another particular advantage is that the constructional unit constituted by the running tube 47 and the piston part 27 prefabricated as a module or component can be used for different accumulator designs and accumulator sizes. In the case of an identical tube diameter and an identically constructed piston part 27, it could be possible to provide different tube lengths for different lengths of the accumulator housing 1.

The exemplary embodiment of FIG. 5 likewise relates to a piston accumulator for a higher pressure level, for example a design pressure of 350 bar. The only difference compared with the exemplary embodiment of FIG. 4 is however that, despite the high pressure level, the housing main part 3 has a thin-walled design. In the present example, the main part 3 is a deep-drawn part with a wall thickness in the circular cylindrical-shaped longitudinal section of 5 mm, with only the base part 7 and the end section 57 forming the connection to the cover part 5 having a greater wall thickness. In order to guarantee the compressive strength of the accumulator housing 1 required for the envisaged pressure level, the main part 3 is surrounded by a cylindrical jacket 59. This is formed from a high-strength composite material, for example from a carbon fiber-reinforced plastic material. This allows the realization of a piston accumulator with a so-called liner construction which, while having a high compressive strength, nevertheless has a particularly low construction weight and which features excellent operating performance thanks to the piston part 27 formed as a light-weight deep-drawn part, and which can furthermore be produced in a particularly economical and cost-effective manner.

1. A hydraulic accumulator, in particular a piston accumulator, in which a piston part (27) separates two media chambers (23, 25) from one another inside an accumulator housing (1), characterized in that the piston part (27) is formed as a deep-drawn part.

2. The hydraulic accumulator according to claim 1, characterized in that the piston part (27) is divided into a guide part (29) and a dome-like trough part (31), which serves to increase the gas working chamber (23) on the gas side of the accumulator, and in that a pressure-balanced separation surface (33) between the two media chambers (23, 25) is formed by the trough part (31) during operation of the accumulator.

3. The hydraulic accumulator according to claim 1, characterized in that the trough part (31) of the piston part (27) has a dome-like curvature, which is adapted to a concave curvature of the inner side (13) of a cover part (5) of the accumulator housing (1) in such a way that the piston part (27) in its one end position in the absence of fluid pressure in the fluid working chamber (25) of the accumulator housing (1) has its trough part lying in full-face contact against the inner side (13) of the cover part (5).

4. The hydraulic accumulator according to claim 1, characterized in that the piston part (27) is guided in each of its displacement positions in a hollow tube or running tube (47) inside the accumulator housing (1).

5. The hydraulic accumulator according to claim 1, characterized in that the accumulator housing (1) has, in addition to the cover part (5), a housing main part (3) and in that the running tube (47) for the piston part (27) is maintained at a spacing from the inner side of this main part (3).

6. The hydraulic accumulator according to claim 1, characterized in that the running tube (47) is supported at its bottom end by means of a retaining ring (53), which is preferably formed from plastic and which has apertures, against the housing main part (3).

7. The hydraulic accumulator according to claim 1, characterized in that the running tube (47) is fixed by means of its end lying at the top to the cover part (5) and in that, for this purpose, the end edge of the cover part (5) has on the inner side a seat for the running tube (47) with a tolerance sleeve (49) and an O-ring seal (51).

8. The hydraulic accumulator according to claim 1, characterized in that the piston part (27) is provided at the external circumference with continuous circumferential groove-like recesses (35, 37) for receiving sealing tape (39) and guide tape (41).

9. The hydraulic accumulator according to claim 1, characterized in that the respective groove-like recess (35, 37) is obtained by means of a rolling process.

10. The hydraulic accumulator according to claim 1, characterized in that one of the groove-like recesses (37) for receiving the guide tape (41) is arranged on one free end region of the piston part (27) inside the guide part (29) and an additional second groove-like recess (35) serves to receive the sealing tape (39) and is arranged in the region of the transition between the guide part (29) and the trough part (31) either on the guide part (29) or on the trough part (31).

11. The hydraulic accumulator according to claim 1, characterized in that the wall thickness of the piston part (27) designed as a hollow piston is essentially the same over the axial extension thereof.

12. The hydraulic accumulator according to claim 1, characterized in that the axial length of the cylindrical guide part (29) is the same as or greater than half of the diameter of this guide part (29).

13. The hydraulic accumulator according to claim 1, characterized in that the piston part (27) designed as a deep-drawn part is formed from a fine grain sheet, in particular from a stainless steel material or an AlMg alloy.
